(19) United States
(12) Patent Application Publication
(10) Pub. No.: US 2008/0124618 A1
(43) Pub. Date: May 29, 2008

(54) Holder for battery modules

(76) Inventor: Yoshiro Shimoyama, Inzai-city (JP)

Correspondence Address: MORGAN, LEWIS & BOCKIUS LLP (SF), One Market, Spear Street Tower, Suite 2800, San Francisco, CA, 94105, US

(21) Appl. No.: 11/648,761

(22) Filed: Dec. 29, 2006

(30) Foreign Application Priority Data
Nov. 29, 2006 (KR) 10-2006-0118844

(51) Int. Cl. H01M 2/10

(52) U.S. Cl. 429/99

(57) ABSTRACT

A holder for battery modules includes a housing in which a cooling air inlet and a cooling air outlet are established on both sides thereof to cool the battery modules. A plurality of terminal receiving recesses are formed on the front and rear ends of the housing to support both ends of the battery modules. The battery modules are accommodated arranged horizontally in the housing and, if the number of the battery modules exceeds a capacity that the housing can accommodate, another housing having the same structure is stacked on the housing and then electrically and mechanically connected to each other to be used as a single set.

### CROSS-REFERENCE TO RELATED APPLICATION

This application claims the benefit of Korean Patent Application No. 10-2006-0118844, filed on Nov. 29, 2006, the entire disclosure of which is hereby incorporated by reference.

### BACKGROUND OF THE INVENTION

1. Field of the Invention

The present invention relates to a holder for battery modules and, more particularly, to a holder for battery modules used in a power supply mounted in a vehicle that charges and discharges a large amount of electric power.

2. Description of Related Art

In general, the battery of a vehicle is a part for supplying electric power to the respective elements of the vehicle and repeats charge and discharge by loads of electronic devices and a generation unit of the vehicle. During such a process, the temperature rise of the battery causes some problems in that the internal resistance in the battery is changed, the electric performance is deteriorated and thereby efficient electricity management of the vehicle is not established. Especially, as the development and application of rechargeable batteries for hybrid vehicles have been recently generalized, a realistic necessity for lowering the internal temperature of the battery to an appropriate level has been raised.

There have been disclosed structures, in which a plurality of battery modules arranged horizontally is put up and down into a housing divided into halves, for example, in Japanese Patent Publication No. 2000-223096 and Japanese Patent Publication No. 2003-331807. However, since such structures require the housing having a separate structure in which the top and bottom are divided, there occurs a problem in that the numbers of component parts and mold frames become larger.

Moreover, in assembling the battery modules in the housing, the housing does not have a function of preventing misassembly of anode/cathode. If there occurs a misassembly, the misassembly of the anode/cathode is detected in the subsequent process of assembling parts such as an end plate or a busbar plate electrically connecting the battery modules.

Accordingly, if the misassembly of the anode/cathode is detected, it is inevitable to carry out an amendment process retroactively to the module assembly process, thus causing a problem in that the number of working processes for such amendment and reassembly is increased.

### SUMMARY OF THE INVENTION

Embodiments of the present invention provide a holder for battery modules in which plural battery modules are stacked and electrically and mechanically connected to one another to be used as one set. Accordingly, the housing needs a single shape and thereby the die for manufacturing the housing requires a single shape, thus reducing the manufacturing cost. Moreover, a misassembly of the anode/cathode can be checked by the terminal receiving grooves coinciding with the terminals of the anode/cathode at an early stage of the process, thus eliminating the amendment process.

In an exemplary embodiment of the present invention a holder for battery modules comprises a housing in which a cooling air inlet and a cooling air outlet are established on both sides thereof to cool the battery modules and a plurality of terminal receiving recesses formed on the front and rear ends of the housing to support both ends of the battery modules. The battery modules are accommodated arranged horizontally in the housing and, if the number of the battery modules exceeds a capacity that the housing can accommodate, another housing having the same structure is stacked on the housing and then electrically and mechanically connected to each other to be used as one set.

As a further exemplary embodiment, the terminals on both ends of the battery module having dimensions and shapes different from each other according to polarities, and the terminal receiving recesses are established on the front and rear ends of the housing correspondingly to the terminal shapes of the battery module.

As another exemplary embodiment, the a module receiving portion supporting the central portion of the battery module is established on the bottom surface of the housing, and a plurality of module support grooves is arranged in a row on the module receiving portion to support the outer circumferential surface of the battery module.

Moreover, a rubber material is established on the module support groove to lessen vibration and impact of the battery module.

Furthermore, the housing further comprises a busbar, inserted and mounted on the front and rear ends thereof, for connecting the battery modules in series, busbar receiving grooves, established externally from the terminal receiving recesses, through which the busbar is inserted, and connecting means for fixing the busbar.

In addition, a concave-convex portion is established on the top and bottom surfaces of the housing for a correct connection.

### BRIEF DESCRIPTION OF THE DRAWINGS

The above and other features of the present invention will be described with reference to certain exemplary embodiments thereof illustrated the attached drawings in which:

FIG. 1 is a perspective view depicting a holder for battery modules in accordance with an exemplary embodiment of the present invention;

FIG. 2 is a side view of FIG. 1; and

FIG. 3 is a perspective view depicting a holder for battery modules in accordance with another exemplary embodiment of the present invention.

### DETAILED DESCRIPTION OF THE INVENTION

Hereinafter, preferred embodiments of the present invention will now be described in detail with reference to the attached drawings.

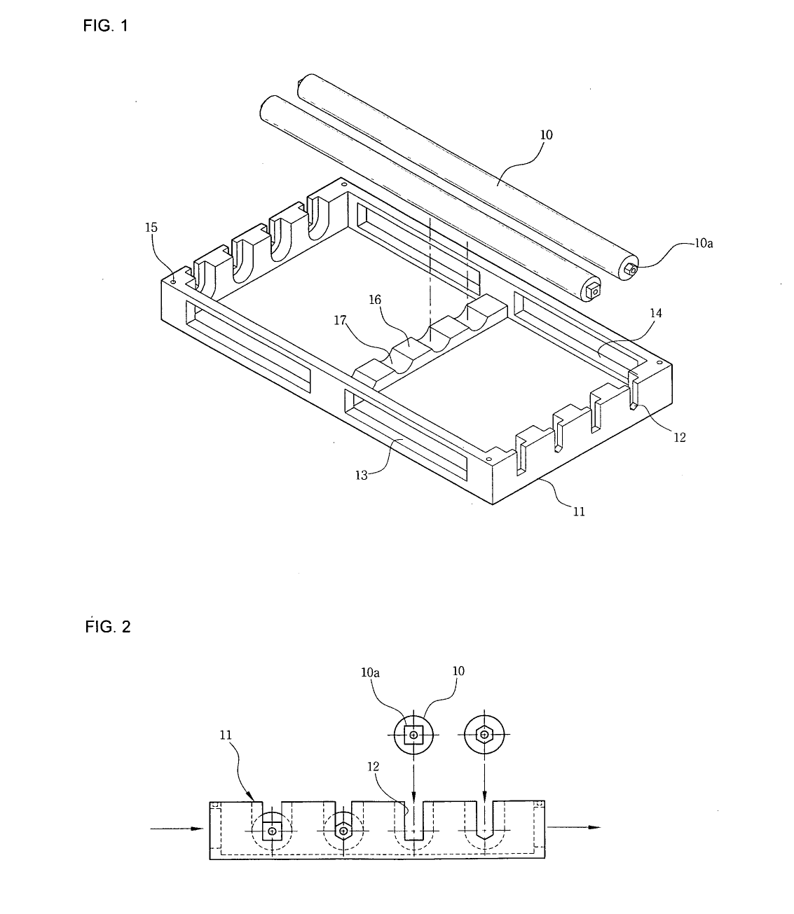

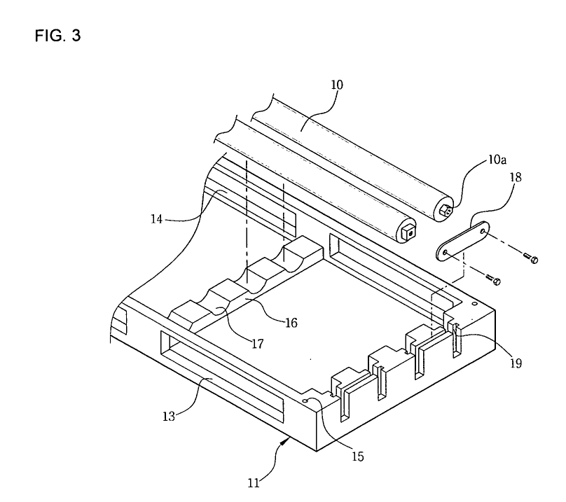

Referring to FIG. 1, in an exemplary embodiment of the present invention, a housing supporting a battery module 10 is configured by a resin material to have electrical insulation and, at the same time, improve productivity by the resin molding. The housing 11 is fabricated in the form of a simple case that accommodates a plurality of battery modules 10. A plurality of terminal receiving recesses 12, into which a plurality of module terminals 10a is inserted, is arranged in a row on both end walls of the housing 11. Moreover, a cooling air inlet 13 and a cooling air outlet 14 are established on left and right sides of the housing 11.

The cooling air inlet 13 and the cooling air outlet 14 perform a role of cooling the battery modules 10 mounted in the housing 11 by circulating cooling air through gaps between the respective battery modules 10 and between the housing 11 and the battery modules 10. Here, the terminal arranged on one end of the battery module 10 has a positive polarity (cathode) and the terminal established on the other end of the battery module 10 has a negative polarity (anode). To distinguish the polarities of the anode and cathode, the dimensions and shapes of the terminals may be set differently from each other. For example, the anode is of rectangular shape and the cathode is of hexagonal shape.

The terminal receiving recesses 12 are formed correspondingly to the shapes of the anode and the cathode different from each other, thus assembling the anode and the cathode correctly. Through-holes 15 are established on the edges of the housing 11. Accordingly, it is possible to connect the plural housings 11 stacked to each other by inserting connecting means such as bolts into the through-holes.

A module receiving portion 16 is formed protruding in the middle portion on the bottom surface of the housing 11 in the horizontal direction, and a plurality of module support grooves 17 is established on the module receiving portion 16 to support the central portion of the battery module 10. The module receiving portion 16 may be established at least one so as to improve assembly performance of the battery module 10 and prevent the central portion of the battery module 10 from being bent due to its weight when the battery module 10 is supported by both ends of the housing 11.

Moreover, a buffering material may be established on the module receiving portion 16 to protect the battery module 10 from vibration or impact applied during the driving of the vehicle. The buffering material may be a rubber material such as EPDM and a resin material such as PPM.

A busbar 18 is provided to electrically connect the battery modules 10 in series mounted in the housing 11. A busbar receiving groove 19 is formed on both ends of the housing 11 externally from the terminal receiving recesses 12. Accordingly, the busbar 18 inserted into the busbar receiving grooves 19 and assembled temporarily is fixed along with the terminals of the battery module 10 using connecting means such as bolts.

In a case where the plural housings 11 are stacked and connected to each other, a concave-convex portion may be formed on the top and bottom surfaces of the housing 11 for the correct connection, thus facilitating the assembling process. Moreover, the up and down housings 11 are connected to each other via the through-holes 15 using connecting means such as bolts.

The housing 11 configured as described above may be a single body accommodating the battery modules 10, and the battery modules 10 can be mounted parallel to one another in a row therein. Furthermore, to accommodate much more battery modules 10 therein, the plural housings 11 having the same structure are stacked and connected to one another.

Accordingly, the present invention has advantages in that the assembly performance of the battery modules 10 is improved and simplified, thus reducing the manufacturing cost. Moreover, it is possible to assemble the battery modules 10 and the busbar 19 through a single process since the terminal receiving recesses 12 harmonized with the dimensions and shapes of the terminals are formed on the housing 11 to distinguish the polarities of the battery module 10 and the busbar receiving grooves 19 for connecting the anodes and the cathodes in series are established on the housing 11.

As described above, the holder for battery modules in accordance with the present invention has the following merits:

1) While the conventional holder comprises up and down parts, the present invention provides a structure in that the housings having a single shape are stacked with each other. Accordingly, the housing needs a single shape and thereby the die for manufacturing the housing requires a single shape, thus reducing the manufacturing cost.

2) The present invention provides a method in which the battery modules are assembled in accordance with the cathode/anode recesses established on the housing. Accordingly, it is unnecessary to check the positions of the battery module in the axial direction, like the conventional art. Moreover, the housings in which the battery modules are mounted can be stacked as much as necessary, thus facilitating the assembly process.

3) The misassembly of the anode/cathode can be checked by the terminal receiving grooves coinciding with the terminals of the anode/cathode at an early stage of the process, thus eliminating the amendment process.

4) While a dedicated part called the end plate for supporting the busbar is mounted in the conventional art, the busbar for electrically connecting the battery modules is inserted in the housing in accordance with the present invention, thus reducing the part cost for the end plate and the die cost as well.

As above, exemplary embodiments of the present invention have been described and illustrated, however, the present invention is not limited thereto, rather, it should be understood that various modifications and variations of the present invention can be made thereto by those skilled in the art without departing from the spirit and the technical scope of the present invention as defined by the appended claims.

What is claimed is:

1. A holder for battery modules, comprising:
a housing in which a cooling air inlet and a cooling air outlet are established on both sides thereof to cool the battery modules; and
a plurality of terminal receiving recesses formed on the front and rear ends of the housing to support ends of the battery modules,
wherein the battery modules are accommodated arranged horizontally in the housing and, if the number of the battery modules exceeds a capacity that the housing can accommodate, another housing having the same structure is stacked on the housing and then electrically and mechanically connected to each other to be used as one set.

2. The holder for battery modules as recited in claim 1, wherein the terminals on both ends of the battery module having dimensions and shapes different from each other according to polarities, and the terminal receiving recesses are established on the front and rear ends of the housing correspondingly to the terminal shapes of the battery module.

3. The holder for battery modules as recited in claim 1 or 2, wherein a module receiving portion supporting the central portion of the battery module is established on the bottom surface of the housing, and a plurality of module support grooves is arranged in a row on the module receiving portion to support the outer circumferential surface of the battery module.

4. The holder for battery modules as recited in claim 3, wherein a resilient material is provided on the module support groove to lessen vibration and impact of the battery module.

5. The holder for battery modules as recited in claim 1 or 2, wherein the housing further comprises a busbar, inserted and mounted on the front and rear ends thereof, for connecting the battery modules in series, busbar receiving grooves, established externally from the terminal receiving recesses, through which the busbar is inserted, and connecting means for fixing the busbar.

6. The holder for battery modules as recited in claim 1 or 2, wherein a concave-convex portion is established on the top and bottom surfaces of the housing for a correct connection.

7. A holder for battery modules, comprising a housing having sides joining front and rear ends, said sides defining a cooling air inlet and a cooling air outlet to cool the battery modules disposed in said housing, and said front and rear ends further defining a plurality of terminal receiving recesses to support ends of battery modules arranged horizontally in the housing, wherein the housing is configured and dimensioned to receive a second housing stacked thereon to increase the capacity of said holder.

8. The holder of claim 7, wherein each said housing has the same structure and is electrically and mechanically connected to each other to be used as one set.

9. The holder of claim 7, wherein said housing further comprises:
a bottom surface at a bottom of the sides and end;
a module receiving portion supporting the central portion of the battery module disposed on said bottom surface; and
a plurality of module support grooves is arranged in a row on the module receiving portion to support the outer circumferential surface of the battery module.

10. The holder of claim 9, further comprising a busbar disposed on the front and rear ends of the housing for connecting the battery modules in series with busbar receiving grooves disposed externally from the terminal receiving recesses, said grooves being configured and dimensioned for insertion of the busbar thereghrough.
